(19) United States
(12) Patent Application Publication
(10) Pub. No.: US 2018/0307821 A1
(43) Pub. Date: Oct. 25, 2018

(54) TOUCH AND SOUND AUTHENTICATION DEVICE

(71) Applicant: BYSTAMP, Vannes (FR)

(72) Inventors: Yann LE BAIL, VANNES (FR); Thierry MAISON, VANNES (FR)

(73) Assignee: BYSTAMP, VANNES (FR)

(21) Appl. No.: 15/769,222

(22) PCT Filed: Oct. 20, 2016
(86) PCT No.: PCT/EP2016/075235

§ 371 Date: Apr. 18, 2018

(30) Foreign Application Priority Data
Oct. 20, 2015 (FR) 1559966

(51) Int. Cl. G06F 21/35; G06F 21/32; G06K 9/00; G06F 3/041; G06F 3/044; G06F 1/16

(52) U.S. Cl. CPC G06F 21/35; G06F 21/32; G06F 1/1684; G06F 3/0414; G06F 3/044; G06K 9/0002

(57) ABSTRACT

An authentication device designed to be used with an electronic device including a capacitive touch screen and a receiver, wherein the authentication device includes a plurality of pins arranged on the same face of the authentication device, at least two pins consisting of a conductive material, the other pins consisting of an insulating material, means for detecting pressure exerted on at least one pin, and means for emitting an authentication signal to be received by the receiver when pressure is detected.

The present invention concerns the field of authentication devices.

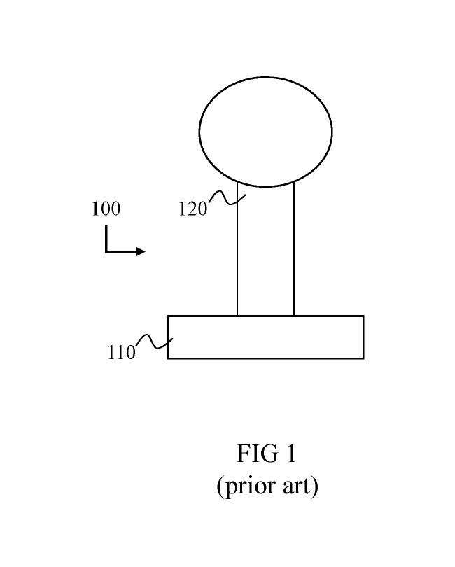

An ink pad 100 as represented in FIG. 1 is a basic authentication or signature device. The ink pad 100 is composed of a handle 120 able to be grasped by a user and a stamp 110, the stamp 110 having an exterior pattern in relief. Such an ink pad 100 is classically used for the authentication of documents. A user of an ink pad 100 first of all needs to press the stamp 110 against an ink pad so that the stamp 110 becomes covered with a layer of ink, and then press the stamp 110 against the document being authenticated in order to imprint a mark there corresponding to the pattern of the stamp 110. The imprinted mark enables an authentication or a signature of the document. There are more sophisticated ink pads, known as self-inking pads, such as described in the French patent application FR 3 016 142. However, the ink pad 100 as well as the self-inking pad described in the aforementioned patent application is used in the same way, the user having to press more or less firmly the ink pad against the document being authenticated or signed. A classical example of the use of an ink pad 100 is the signing of delivery notes by companies, the signing being done by a “rubber stamping” of the delivery note.

The level of authentication provided by such devices is very weak, since it is easy to reproduce the pattern of a stamp, and furthermore this same pattern is used repeatedly without modification. It is thus possible to reproduce it and use the reproduction in a fraudulent manner.

What is more, this basic method of authentication is still in frequent use, not having been adapted to paperless documents. In fact, it is necessary to go through a first phase where the document is authenticated by the use of an ink pad, then a second phase where the authenticated document is scanned. This process is long and tedious.

It is thus necessary to propose an authentication device which can mitigate the inconveniences of existing ink pads while still preserving the simplicity of use of these ink pads.

The present invention relates to an authentication device designed to be used with an electronic device comprising a capacitive touch screen and a receiver, the authentication device being characterized in that it comprises a plurality of pins arranged on the same face of the authentication device, at least two pins consisting of a conductive material, the other pins consisting of an insulating material, all the pins having an identical appearance, means for detecting pressure exerted on at least one pin, and means for emitting an authentication signal to be received by the receiver when pressure is detected, the authentication signal being a sound signal.

Advantageously, the authentication device can replace an ink pad for use in a process of paperless authentication. The pins consisting of a conductive material enable a detection, by a capacitive touch screen of an electronic device, of a pattern associated with the disposition of said conductive pins. The means for detecting pressure makes it possible to ensure that the authentication sound signal is only issued when the authentication device is used, for example, by being placed in contact with the touch screen of an electronic device. The use of an authentication by combination of an authentication sound signal and a pattern enables all the possibilities of an authentication by sound signal (availability of electronic devices having a microphone, infinity of available sound code). The combination of an authentication by combination of an authentication sound signal and a pattern, the latter requiring a physical contact, makes it possible to ensure that only the electronic device against which the authentication device is pressed can execute an authentication process with success.

According to one supplemental embodiment of the invention, the geometrical positioning of the pins consisting of conductive material constitutes a pattern, the pattern being associated with the authentication signal.

Thus, the authentication device offers a supplemental level of security during the detection of a sound signal, that sound signal being associated with a pattern. Thus, only the electronic device against which the authentication device is pressed and on which the pattern can be detected is able to verify that the sound signal and the pattern match up.

According to one supplemental embodiment of the invention, the authentication device is at least partially made of a conductive material, an electrical continuity being ensured with the pins consisting of a conductive material.

Thus, the authentication device, held in the hand of a user, can be used on a capacitive touch screen of an electronic device. The electrical continuity is realized between the user and the capacitive touch screen.

According to one supplemental embodiment of the invention, the conductive material constituting the pins and/or the authentication device is flexible.

Thus, the authentication device can be used without risk of scratching or damaging a screen of an electronic device.

According to one supplemental embodiment of the invention, the authentication device comprises a monobloc and hollow body consisting of a flexible material which is a conductor of electricity, the body comprising at least one groove enabling the insertion of a support plate consisting of an electrically conductive material on which the pins are supported, the interior of the body of the authentication device constituting a Faraday cage.

Thus, the authentication device is easy to produce and sturdy. Likewise, electronic components placed inside the authentication device are protected against electromagnetic interference.

According to one supplemental embodiment of the invention, the authentication device further comprising means of reading a fingerprint when a pressure is detected on at least one pin, the authentication signal only being emitted if the fingerprint read corresponds to a predetermined fingerprint.

Thus, a level of security is provided, since the authentication device can only be used by a predetermined user.

According to one supplemental embodiment of the invention, at most four pins consisting of a conductive material, the other pins consisting of an insulating material.

Thus, a capacitive touch screen of an electronic device can quickly detect a pattern composed by the pins consisting of a conductive material. Moreover, the compatibility of the authentication device with capacitive touch screens not being able to detect more than four contact points at the same time is guaranteed.

The present invention also relates to a method for authentication of an identifier associated with an authentication device, the method being executed by an electronic device comprising a capacitive touch screen and a receiver and involving the steps of receiving the selection of a first identifier associated with a first authentication device, retrieving a first authentication signal and a first pattern associated with the first identifier, detecting at least two input points on the capacitive touch screen created by the application of a second authentication device on the capacitive touch screen, determining a second pattern as a function of the input points detected, receiving a second authentication signal by means of the receiver, authenticating the first identifier if the second authentication signal is equal to the first authentication signal and if the second pattern is equal to the first pattern

According to one supplemental embodiment of the invention, the step of determining a second pattern involves a step of calculating at least one distance between the input points detected on the capacitive touch screen.

The present invention also relates to a computer program, which may be stored on a data medium and/or downloaded from a communication network, in order to be read and executed by a processor or implemented in a microcontroller. This computer program comprises instructions for implementing the method mentioned above according to any one of its variants. The invention also relates to data storage means comprising such a computer program.

The above-mentioned characteristics of the invention, as well as others, will appear more clearly upon reading the following description of a sample embodiment, this description being given in relation to the accompanying drawings, of which:

FIG. 1 illustrates schematically an ink pad known in the prior art;

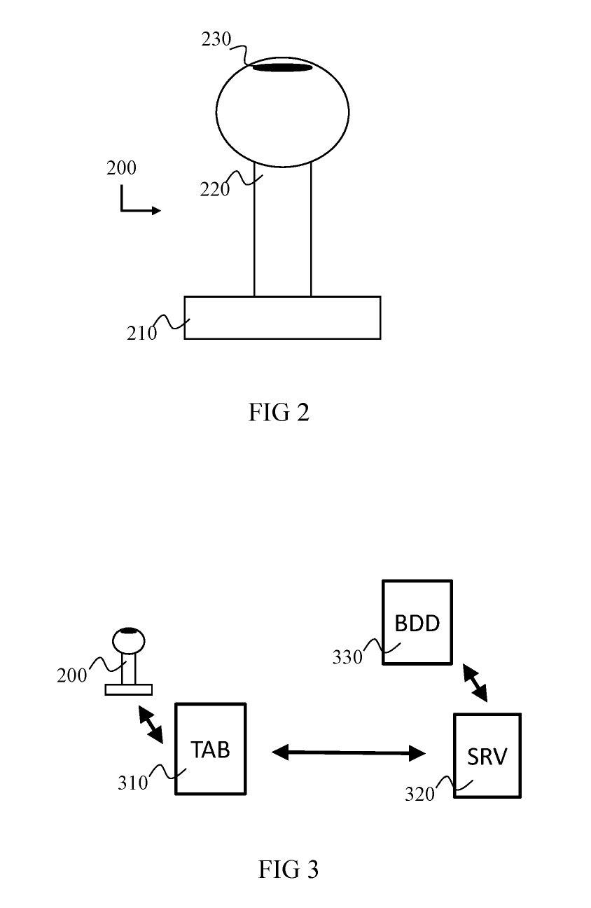

FIG. 2 illustrates schematically an example of the outer appearance of an authentication device according to one embodiment of the present invention;

FIG. 3 illustrates schematically a system according to one embodiment of the invention;

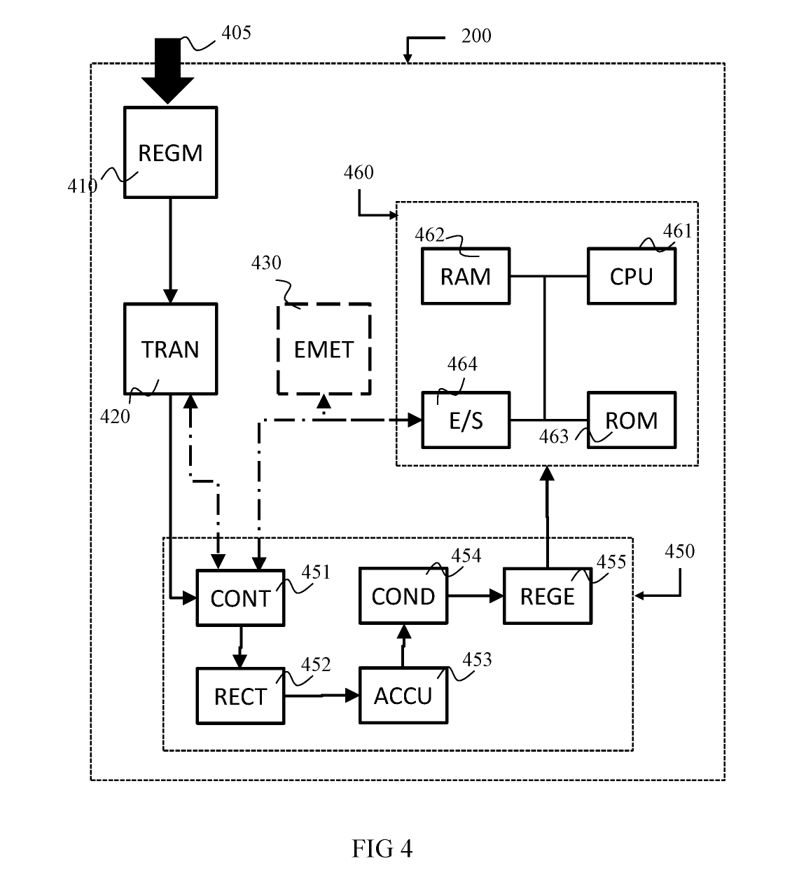

FIG. 4 illustrates schematically an example of hardware architecture of an authentication device according to one embodiment of the invention;

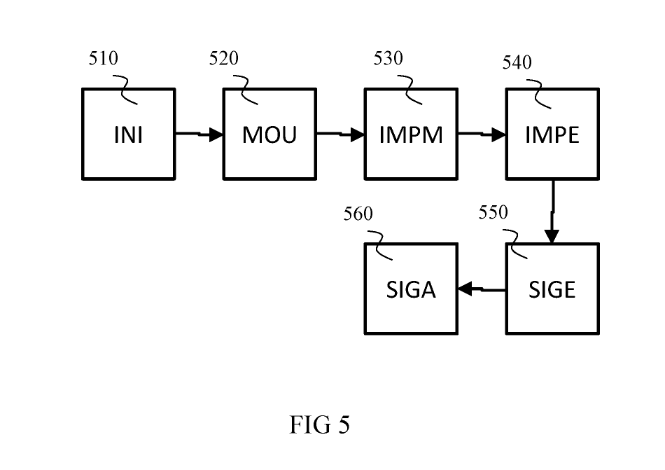

FIG. 5 is a flow chart of a method for issuing an authentication signal according to one embodiment of the invention;

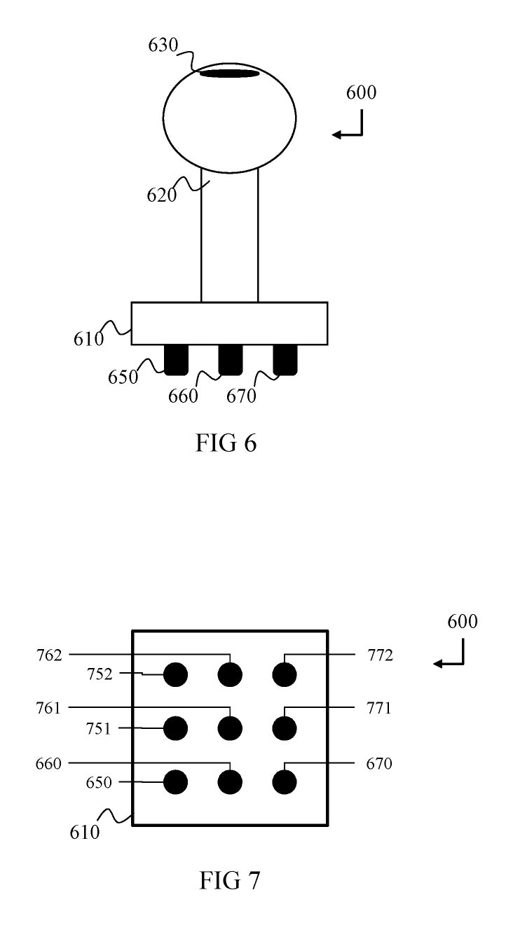

FIG. 6 illustrates schematically an example of the outer appearance of an authentication device according to a supplemental embodiment of the present invention;

FIG. 7 is a bottom view of the authentication device according to the supplemental embodiment of the invention as illustrated in FIG. 6;

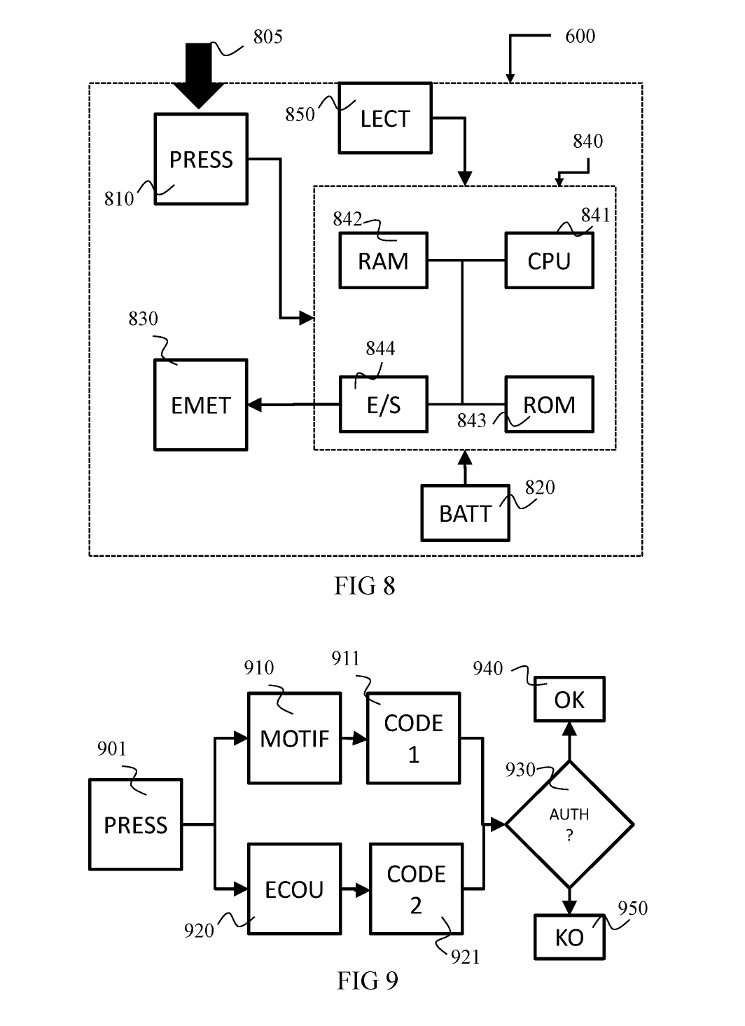

FIG. 8 illustrates schematically an example of hardware architecture of an authentication device according to the supplemental embodiment of the invention as illustrated in FIG. 6;

FIG. 9 is a flow chart of a method of authentication utilizing an authentication device according to the supplemental embodiment of the invention as illustrated in FIG. 6;

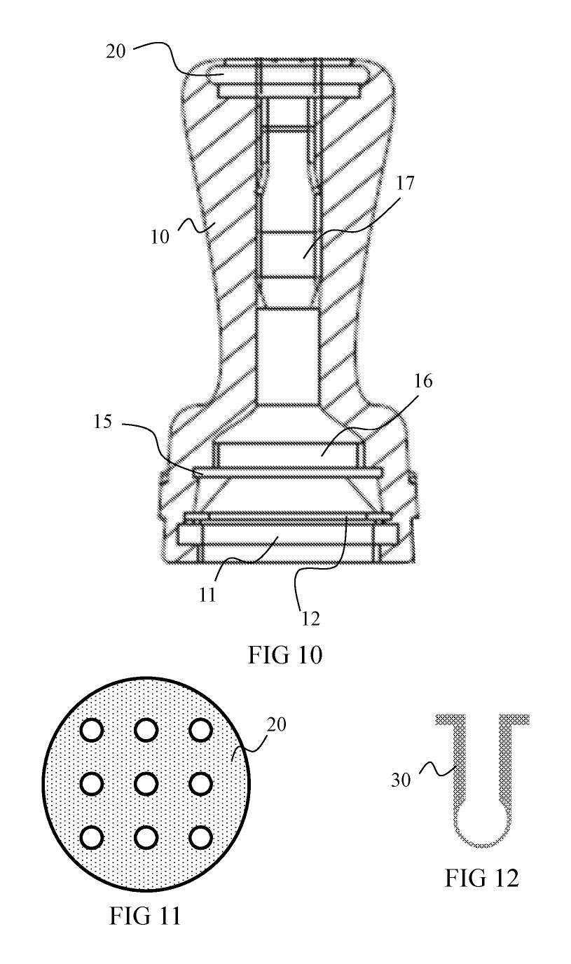

FIG. 10 is a cross section view of a body of an authentication device according to a supplemental embodiment of the present invention;

FIG. 11 is an illustration of a part designed to be integrated in the authentication device as illustrated in FIG. 10;

FIG. 12 is a cross section view of a pin designed to be integrated in the authentication device as illustrated in FIG. 10.

FIG. 2 illustrates schematically an example of the outer appearance of an authentication device according to one embodiment of the present invention. According to this embodiment, the outer appearance of the authentication device 200 is very similar to the ink pad 100. Thus, the authentication device 200 may be composed of a handle 220 and a portion 210, known as the “stamp”, similar in its form to the stamp 110 of the ink pad 100. The handle 220 may be partly or fully telescopic in order to accommodate in it a mechanical pulse regulator REGM 410 which is described below.

According to one embodiment of the invention, the authentication device 200 comprises a fingerprint reader 230, such as one located on top of the handle 220 so as to be easily used by a user who may place their finger there, typically their thumb.

According to one embodiment of the invention, the authentication device 200 has no means of opening or disassembly once assembled or manufactured.

According to one embodiment of the invention, the authentication device 200 has an external communication interface, such as, for example, a USB port (Universal Serial Bus) or a wireless interface of near field communication type (NFC), not represented here, allowing it to be configured, for example. Alternatively, the authentication device 200 has no external communication interface. In this case, a configuration of the authentication device 200, that is, the internal components of the authentication device 200 as are described hereafter, can be done before the body of the authentication device 200 is fully assembled, and for example welded.

FIG. 3 illustrates schematically a system according to one embodiment of the invention, the system being composed of a first authentication device 200 as described previously, a second device TAB 310 being able to receive an authentication signal emitted by said first authentication device 200 and a server SRV 320, said server SRV 320 comprising or being able to access a database BDD 330. Thus, according to this embodiment of the invention, the device TAB 310 is typically a digital tablet or an intelligent telephone (smartphone) executing an application enabling a paperless management of signatures or authentication signals. Advantageously, the device TAB 310 may be a digital tablet or a smartphone commonly commercially available if, for example, the authentication device 200 emits an authentication sound signal. Indeed, a microphone of the device TAB 310 is then used to capture this authentication signal.

According to one possible scenario of use of the authentication device 200, the device TAB 310 is used to receive a signature, for example, if this device is used by mail carriers who deliver a piece of mail in return for a signature by a recipient using the authentication device 200. The application on the device TAB 310 lets the device TAB 310 hear a possible authentication sound signal (the sound signal being possibly emitted in the ultrasound band). The user of the authentication device 200 performs a usage gesture of a classical ink pad 100 above the device TAB 310, the gesture enabling, as described below, an energizing of the authentication device 200 and an emitting of an authentication sound signal. This authentication sound signal may be of low intensity, inasmuch as the authentication device 200 has slight power resources, but also in order to preserve the confidentiality of the emitting of the authentication sound signal which is thus less easily picked up at great distance. In other words, an authentication sound signal of low intensity guarantees a greater confidentiality, but requires a proximity, during the emitting of that sound signal, between the authentication device 200 and the device TAB 310. The device TAB 310, receiving via a microphone the authentication sound signal, calculates a first bit of information, comprising for example an identifier of the authentication device 200, and sends a request to the server SRV 320 containing this first bit of information. The server SRV 320, based on the first bit of information received, polls the database BDD 330 and retrieves one or more bits of identification information associated with the first bit of information. The server SRV 320 sends this identification information to the device TAB 310, which thus enables the application executed by the device TAB 310 to sign the receipt of the letter by the client using the authentication device 200.

FIG. 4 illustrates schematically an example of hardware architecture of an authentication device 200 according to one particular embodiment of the invention. In this embodiment, the authentication device 200 comprises a mechanical pulse regulator REGM 410, an electromechanical transducer TRAN 420, a power supply module 450, a microcontroller 460 and possibly a transmitter EMET 430. In FIG. 4, an arrow 405 symbolizes a placing of the authentication device 200 in movement, produced by a user, for example. The placing of the authentication device 200 in movement may be done by the user holding the authentication device 200 by the handle 220, as previously described, and imposing on the authentication device 200 a gesture similar to that of a “rubber stamping” used with the ink pad 100.

The mechanical pulse regulator REGM 410 is a mechanical device able to transform a gesture or a placing of the authentication device 200 in movement, of potentially random nature, into a mechanical pulse of predetermined characteristics during each use of the authentication device 200 by a user. The transformation of the placing in movement into a mechanical pulse of predetermined characteristics may involve an intermediate phase of accumulation and storage of mechanical energy associated with the placing in movement. For example, the mechanical pulse regulator REGM 410 is able to generate a constant mechanical impulse, corresponding to a cocking, by the gesture of placing the authentication device 200 in movement by a user, and then a releasing of a striker mounted for example on a spring. Thus, a constant mechanical impulse is generated by the mechanical pulse regulator REGM 410 following a placing in movement by a single gesture or by multiple gestures of a user of the authentication device 200, for example, by one or more pressings of the authentication device 200 against a firm surface such as the device TAB 310. The placing in movement may be done with a gesture similar to the use of an ink pad 100, for example, by pressing the authentication device 200 against the device TAB 310, the mechanical pulse regulator REGM 410 being able to convert this pressing, potentially of variable duration or pressure, into a homogeneous mechanical impulse, that is, one of overall constant characteristics. In other words, the characteristics of the mechanical impulse at the output of the mechanical pulse regulator REGM 410 are overall similar during each use of the authentication device 200.

According to another, supplemental or alternative embodiment of the invention, the placing of the authentication device 200 in movement is done by a rectilinear movement, for example, in the axis of the handle 220, the movement possibly including back and forth movements. The mechanical pulse regulator REGM 410 may comprise an oscillating flyweight. The placing of the authentication device 200 in movement enables the placing of the oscillating flyweight in movement and the cocking of a spring accumulating the mechanical energy. In this embodiment, the authentication device 200 comprises a detector (not shown), such as a switch, placed on the so-called stamp part 210 of the authentication device 200. The detector is able to detect the pressing of the authentication device 200 against a surface, such as a surface of the device TAB 310, and to release a striker, thereby releasing the mechanical impulse when the authentication device 200 is pressed against the device TAB 310. The detector, such as a switch, is thus able to ensure that the authentication device 200 is at a close distance from the device TAB 310 so as to enable the exchanging of sound signals. Once again, the characteristics of the mechanical impulse at the output of the mechanical pulse regulator REGM 410 are overall similar during each use of the authentication device 200.

The electromechanical transducer TRAN 420 receives at its input the mechanical impulse at the output of the mechanical pulse regulator REGM 410. The electromechanical transducer TRAN 420 is an electrical generator type device able to convert the mechanical impulse received at its input into an electrical pulse. The electromechanical transducer TRAN 420 for example may be an electromechanical transducer of piezoelectric type, implementing a so-called “direct” piezoelectric effect in order to convert the mechanical impulse into an electrical pulse. The electromechanical transducer TRAN 420 may thus be a ceramic or a piezoelectric composite. The electromechanical transducer TRAN 420 may also be a dynamoelectric machine, known as a micro-dynamo, or an alternator. The electromechanical transducer TRAN 420 is thus able to convert a mechanical energy into an electrical energy, for the purpose, as explained below, of feeding electrical energy to a microcontroller. The output of the electromechanical transducer TRAN 420 is thus an electrical pulse corresponding to the mechanical impulse received at the input.

The power supply module 450 receives the electrical pulse generated by the electromechanical transducer TRAN 420. The power supply module 450 has the functionality of converting the electrical pulse received at the input of the power supply module 450 into an electrical power supply adapted to a power supply for a microcontroller 460. The power supply module 450 is able to absorb the electrical surges associated with the arrival of electrical energy in the form of electrical pulses coming from the electromechanical transducer TRAN 420 and to accumulate this electrical energy in order to deliver it to the microcontroller 460 with a voltage adapted to the microcontroller 460 during a period of time sufficient for the microcontroller 460 to execute the instructions necessary for the process of emitting an authentication signal.

According to one particular embodiment of the invention, the power supply module comprises an electrical signal controller CONT 451, an electrical pulse rectifier RECT 452, an electric energy accumulator ACCU 453, an electric flow conditioner COND 454 and an electric flow regulator REGE 455. The electrical signal controller CONT 451 receives at its input the electrical pulse furnished by the electromechanical transducer TRAN 420 and transmits it to the electrical pulse rectifier RECT 452. The electrical pulse rectifier RECT 452 is able to convert an electrical signal corresponding to the electrical pulse received, which is an alternating signal, into a positive or rectified signal. The electrical pulse rectifier RECT 452 may comprise an electrical rectifier or a converter of alternating to direct current. The electric energy accumulator ACCU 453 receives the electrical signal so rectified by the electrical pulse rectifier RECT 452 and enables the storing of electrical energy corresponding to the electrical signal so received. The electric energy accumulator ACCU 453 may for example comprise a capacitor or a rechargeable battery. The electrical energy is thus stored by the electric energy accumulator ACCU 453 in a temporary or permanent manner, depending on the technology used by the electric energy accumulator ACCU 453. The electric flow conditioner COND 454 is able to manage the electrical energy stored in the electric energy accumulator ACCU 453, that is, to release this accumulated energy when one or more predetermined conditions are fulfilled. For example, the electric flow conditioner COND 454 may comprise a detector of electrical voltage at the terminals of the electric energy accumulator ACCU 453, and condition the releasing of the stored electrical energy upon reaching a certain electrical voltage. Thus, the electric flow regulator REGE 455 only receives the electrical energy stored in the electric energy accumulator ACCU 453 if, for example, this energy has been stored in sufficiently large quantity. A representation of the energy stored by the electric energy accumulator ACCU 453 may be obtained, for example, by measuring a voltage on the terminals of the electric energy accumulator ACCU 453. Thus, according to one embodiment of the invention, the electric flow regulator REGE 455 only receives the electrical energy stored in the electric energy accumulator ACCU 453 if the voltage at the terminals of the electric energy accumulator ACCU 453 is greater than a predetermined value. The electric flow regulator REGE 455 has the function of conditioning the electrical energy received upstream from its microcontroller 460 in order to feed the latter with electrical energy. The conditioning may involve an adapting of the electrical power supply voltage of the microcontroller 460, for example. In fact, the microcontroller 460 may need to be fed at a certain voltage in order to function properly. Thus, the devices 453, 455 and 456 make it possible to ensure that a sufficient quantity of energy is stored in the electric energy accumulator ACCU 453 to feed the microcontroller 460, this electrical energy having been conditioned prior to feeding the microcontroller 460 by the electric energy regulator REGE 455. The power supply module thus makes it possible to feed the microcontroller 460 for a certain length of time and under predetermined characteristics (such as an input voltage of the microcontroller 460).

The microcontroller 460 is an electronic device comprising a programmable data processing unit (Central Processing Unit) CPU 461, a random access memory RAM 462, a nonvolatile memory or storage module ROM 463 and one or more input/output interfaces E/S 464. The interfaces E/S 464 may comprise analog-digital (CAN) or digital-analog (CNA) signal converters, which may comprise a pulse width modulation (PWM) module. When electrically energized by the power supply module 450, the microcontroller 460 is adapted to generate the emission of a first electrical signal at the output of an output interface E/S 464, the first electrical signal corresponding to the authentication signal to be emitted.

According to alternative embodiments, the functionalities of the microcontroller 460 are performed by a programmable logic circuit (field-programmable gate arrays—FPGA), a digital signal processor (DSP), an application-specific integrated circuit (ASIC) or any other equivalent device.

According to one particular embodiment, said interface E/S 464 is connected to a transmitter EMET 430, which then emits the authentication signal. Depending on the nature of the transmitter EMET 430, this may be a signal of sound type (transmitter EMET 430 of loudspeaker type, for example), of visual type (transmitter EMET 430 of light-emitting diode type, for example), or any other type.

According to one embodiment of the invention, the transmitter EMET 430 is a transmitter compatible with radio type technologies such as, for example, Bluetooth®, near field communication (NFC) or radio-frequency identification (RFID). According to one supplemental embodiment, the transmitter EMET 430 is a transmitter-receiver, that is, it may also receive a signal and enables bidirectional communication.

Thus, this authentication signal is designed to be received by the device TAB 310, which comprises a means of reception adapted to the signal emitted, for example a microphone in the case of an authentication sound signal. The use of an authentication signal of sound type thus allows a broad compatibility of the uses of the authentication device 200 with devices TAB 310, which very often contain a microphone.

According to one supplemental embodiment, a predetermined bit of information is recorded in the nonvolatile memory ROM 463 of the microcontroller 460. This information may be recorded in the memory during the course of the fabrication of the authentication device 200 or during a later phase of configuration of the authentication device 200, for example by means of a programming interface, not shown. The predetermined information may include several bits of information such as an identifier of the authentication device 200 or an encryption key.

According to one embodiment, the nonvolatile memory ROM 463 is of the non-rewritable type, and thus it is no longer possible to modify or erase the predetermined information once this has been recorded.

It should be noted that, according to one embodiment, a program containing operating instructions of the microcontroller is recorded in this nonvolatile and non-rewritable memory ROM 463. This makes it possible to guard against any modification of the mode of operation of the authentication device 200. Thus, when the microcontroller 460 is energized by the power supply module 450, the microcontroller 460 may be adapted to retrieve the predetermined information recorded in the memory or storage module ROM 463 and to generate from this predetermined information the emission of a first electrical signal corresponding to the authentication signal to be emitted.

According to one embodiment, the microcontroller 460 increments during each use a first counter whose value may be stored in the memory ROM 463. The electrical signal may be generated from the value of this first counter, incremented during each use, and from an identifier and an encryption key included in the predetermined information. Thus, the first electrical signal is different during each use, and so is the authentication signal emitted, which reduces the possibilities of an attack of the replay attack type in a system composed of the authentication device 200, the device TAB 310 and the server SRV 320. For this, the device TAB 310 may keep in memory the last value received from the first counter and verify, upon receiving a new authentication signal, that the new value received from the first counter is in fact different from or greater than the previous value kept in memory. In the case of a first counter whose value is incremented upon each emission of an authentication signal by the authentication device 200, if the value of the first counter of an authentication signal received is less than or equal to the value previously kept in memory by the device TAB 310, this means that said authentication signal received is a replay authentication signal; the device TAB 310 in this case should deny the authentication.

According to one particular embodiment of the present invention, the electromechanical transducer TRAN 420 is an electromechanical transducer of piezoelectric type. This electromechanical transducer TRAN 420 is then also used as a transmitter EMET 430 for the issuing of the authentication signal, the authentication signal being of the sound type. According to this embodiment, the power supply module 450 is connected to the electromechanical transducer TRAN 420 and to the microcontroller 460.

In this embodiment, the power supply module 450 is able to receive the electrical pulse coming from the electromechanical transducer TRAN 420 of piezoelectric type in order to generate the electrical power supply of the microcontroller 460 while protecting this same microcontroller against any voltage surge, and to transmit the first electrical signal emitted by the microcontroller to the electromechanical transducer TRAN 420 of piezoelectric type, used as the transmitter EMET 430, in order to generate the authentication signal of sound type. According to a more particular embodiment of this embodiment, it is the electrical signal controller CONT 451 of the power supply module 450 which is adapted to receive the electrical pulse coming from the electromechanical transducer TRAN 420 in order to generate the electrical power supply, while protecting the microcontroller 460, and to transmit the first electrical signal coming from the microcontroller 460 to the electromechanical transducer TRAN 420, used as the transmitter EMET 430, in order to generate the authentication signal of sound type. These latter embodiments takes advantage of the capabilities of a piezoelectric transducer to be used alternatively in a so-called “direct” mode (generating an electrical voltage under the action of a mechanical force) or in a so-called “inverse” mode (deformation of the piezoelectric transducer when an electrical voltage is applied to it). The deformations of the electromechanical transducer TRAN 420 of piezoelectric type are then utilized to generate a sound signal. Using the same element for two different functions (electromechanical transducer TRAN 420 and transmitter EMET 430) enables reducing the manufacturing cost and the footprint of the authentication device 200.

According to one supplemental embodiment of the invention, the electromechanical transducer TRAN 420 of piezoelectric type is adapted to pick up a sound signal, corresponding to a message, and to transmit to the power supply module 450 a second electrical signal corresponding to the sound signal picked up by the electromechanical transducer TRAN 420 of piezoelectric type, the power supply module 450 being adapted to transmit to the microcontroller 460 this second electrical signal, the microcontroller 460 being adapted to process this second electrical signal corresponding to a message. For example, the microcontroller 460 may generate a third electrical signal corresponding to a sound signal to emit or record in the memory RAM 462 or ROM 463 a bit of information extracted from the second electrical signal or message. One use of this functionality of reception of a message associated with the second electrical signal is described below for the recording of user identification information in a nonvolatile memory ROM 463.

According to one supplemental embodiment, the authentication device 200 comprises a fingerprint reader 230. This fingerprint reader 230 makes it possible for the issuance of the authentication sound signal to be contingent upon the detection of one or more predetermined fingerprints. This allows the providing of a supplemental level of security by guaranteeing that the user of the authentication device 200 is authorized to make use of it. Thus, information corresponding to the fingerprints of the users authorized to make use of the authentication device 200 may be previously recorded in the nonvolatile memory ROM 463 during the manufacturing phase or during a later phase of configuration. If, during the use of the authentication device 200, no print corresponding to a print registered in the nonvolatile memory ROM 463 is retrieved by the microcontroller 460, then the process of issuing the authentication signal is halted, without issuing an authentication signal. According to one supplemental embodiment of the invention, a predetermined signal corresponding to an error code is then issued in place of the authentication signal. According to an alternative embodiment of the invention, a random signal is issued in place of the authentication signal.

According to one supplemental embodiment of the invention, data corresponding to the fingerprint read by the fingerprint reader 230 is contained in the authentication signal emitted by the authentication device 200. The functionality of verification of the fingerprint based on data corresponding to the fingerprint read may thus be shifted to the device TAB 310 or to the server SRV 320.

According to one embodiment of the invention, the authentication device 200 comprises a first indicator, which lights up when the electrical energy accumulated by the power supply module 450 is sufficient to power the microcontroller 460. The first indicator thus furnishes information indicating whether the energy accumulated by the power supply module 450 is sufficient. Thus, when following one or more movements of the authentication device 200 the light-emitting diode does not light up, the user of the authentication device 200 knows that the authentication device 200 is not able to emit the authentication signal, which induces him to repeat his movement.

FIG. 5 is a flow chart of a method for issuing an authentication signal according to one embodiment of the invention. The method can be executed by a device such as the authentication device 200 described in the present document.

A first step INI 510 corresponds to a phase of initialization of the authentication device 200. This first step can be performed during the manufacturing of the authentication device 200 and it involves the recording in the nonvolatile memory ROM 463 of the microcontroller 460 of a micro program or computer program containing instructions for the execution of the process of emitting an authentication signal. This first step may also include the recording in the nonvolatile memory ROM 463 of a predetermined bit of information. This predetermined information may comprise a unique identifier associated with the authentication device 200 and an encryption key. The predetermined information may also comprise any information enabling the identification of the user of the authentication device 200, such as the name of a company or of the user. If this information is not available during the stage of manufacturing or initialization of the authentication device 200, it is possible to record information in a later stage by a procedure described below.

A second step MOU 520 corresponds to a placing of the authentication device 200 in movement by a user. This placing in movement may obey certain constraints depending on the embodiment of the present invention. In one preferred embodiment, the placing in movement is done by a gesture similar to that when using the ink pad 100.

A following step IMPM 530 corresponds to a conversion of the movement or movements applied to the authentication device 200 during the previous step MOU 520 into a mechanical impulse of predetermined characteristics. This conversion can be accomplished by the mechanical pulse regulator REGM 410 as previously described.

A following step IMPE 540 corresponds to a conversion of said mechanical impulse into an electrical pulse. This conversion can be accomplished by the electromechanical transducer TRAN 420 as previously described.

In a following step SIGE 550, an electrical power supply of predetermined characteristic and adapted to energize means of generating a first electrical signal corresponding to the authentication signal to be emitted is generated from said electrical pulse. The previously described power supply module 450 may accomplish this step SIGE 550.

In a step SIGA 560, the authentication device 200 emits the authentication signal based on the first electrical signal generated during the previous step. According to one embodiment of the invention, a transmitter EMET 430 emits the signal. According to another embodiment of the invention, the electromechanical transducer TRAN 420 is a piezoelectric transducer and it is also used to emit the authentication sound signal.

According to one embodiment of the invention where it is necessary to finalize the configuration of the authentication device 200 after the manufacturing phase, for example to provide the portion of the predetermined information recorded in the nonvolatile memory ROM 463 containing identification information of a user, it is possible to take advantage of the capability of reception of a sound signal by the electromechanical transducer TRAN 420 of piezoelectric type. Thus, in response to the emitting by the authentication device 200 of an authentication signal, the device TAB 310 emits a sound signal corresponding to a message containing a bit of identification information, which is picked up by the electromechanical transducer TRAN 420 of piezoelectric type. The message corresponding to this sound signal is received, in the form of an electrical signal, and processed by the microcontroller 460. The microcontroller 460 retrieves from the message the identification information of the user and records this information in association with the predetermined information in the nonvolatile memory ROM 463. According to one embodiment of the invention, all or some of the nonvolatile memory ROM 463 is non-rewritable, that is, information recorded in the nonvolatile memory ROM 463 can no longer be modified or erased afterwards.

According to one supplemental embodiment of the invention, the device TAB 310 emits the sound signal corresponding to the message containing a bit of identification information, the message also containing a value corresponding to a second counter. The microcontroller 460 retrieves from the message this value for the second counter and records it in a rewritable portion of the nonvolatile memory ROM 463. The value of this second counter corresponds to a limitation of the number of uses of the authentication device 200 to generate an authentication signal. Thus, during each generation of an authentication signal, the authentication device 200 decrements the value of the second counter recorded in the nonvolatile memory ROM 463. When the value of the second counter reaches a predetermined value, such as zero, the authentication device 200 is blocked, preventing any further generation of an authentication signal. In other words, during the step of generating an authentication signal the microcontroller 460 retrieves the value of the second counter and compares it to a predetermined value. If the value of the second counter is less than, or possibly equal to the predetermined value, then the microcontroller cancels the generating of the authentication signal, possibly generating in its place a predetermined error signal or a random signal. It is thus necessary to start again the procedure for initialization of the value of the second counter with a device TAB 310 to reactivate the authentication device 200, the reactivation being good for a number of uses, that is, generations of an authentication signal, depending on the new value of the second counter. In other words, the authentication device 200 records in the nonvolatile memory ROM 463 a value corresponding to a second counter and decrements this value at each use of the authentication device 200 to generate an authentication signal. The authentication device 200 blocks the generating of an authentication signal when the value of the second counter reaches a predetermined value.

According to a supplemental embodiment, the authentication device 200 includes a module of clock type (not represented) connected to or integrated in the microcontroller 460. This clock module may include a battery or cell providing it with energy autonomy. For example, a lithium battery may provide an operating life of the clock module on the order of ten to twenty years. The clock module provides the microcontroller 460 with temporal information such as the time or date. The microcontroller 460 may use this temporal information coming from the clock module for the generating of the first electrical signal corresponding to the authentication signal. In addition, information of time or date type may be recorded in the nonvolatile memory ROM 463. This information may be recorded in a portion of the nonvolatile memory ROM 463 which is rewritable or on the contrary in a portion of the nonvolatile memory ROM 463 which is non-rewritable. In the former case, the microcontroller 460 may update this information based on messages received. This information makes it possible to monitor the functioning of the authentication device 200. Thus, the microcontroller 460 may integrate a step of verification of the date or the current time in order to generate the issuing of an authentication signal. If the date or the current time corresponding to the temporal information coming from the clock module does not correspond to predetermined criteria depending on information of time or date type recorded in the nonvolatile memory ROM 463, the microcontroller 460 cancels or blocks the issuance of the authentication signal. According to one usage scenario, the authentication device 200 thus contains a date, recorded in the nonvolatile memory 463, beyond which the microcontroller 460 will block the issuing of an authentication signal. This scenario thus enables a checking of the service life of the authentication device 200, rendering it non-operational past a certain date. According to another supplemental scenario, the issuance of an authentication signal is only authorized during certain days, such as Monday through Friday, or during certain time slots, such as during work hours. According to another supplemental usage scenario, the authentication device 200 generates a different authentication signal depending on the temporal information arriving from the clock module. Thus, a first authentication signal may be issued during a first time slot, corresponding for example to a first identifier, and a second authentication signal outside of this first time slot, corresponding to a second identifier. In addition, temporal information arriving from the clock module may be encrypted with the encryption key of the authentication device 200 and integrated in the authentication signal issued. According to one embodiment of the invention, the server SRV 320 may validate an authentication signal transmitted by using the encrypted temporal information transmitted. For example, the server SRV 320 may validate an authentication signal if the time discrepancy between the local time of the server SRV 320 and the encrypted temporal information received is less than a predetermined value.

According to an alternative embodiment of the invention, the authentication device 200 comprises a receiver (not represented). This receiver may be for example of the photoelectric cell type, and thus it may pick up or receive a light signal. Such a photoelectric cell may comprise, for example, a diode receiver, a photodiode or a phototransistor. This receiver is connected to the microcontroller 460 and makes it possible to transmit to it an electrical signal corresponding to a light signal received. This receiver may be used as an alternative to the electromechanical transducer TRAN 420 of piezoelectric type for the sole function of receiving a signal, in an embodiment where the device TAB 310 emits a light type signal and not a sound signal.

According to one supplemental embodiment of the invention, the receiver is the transmitter EMET 430, that is, the transmitter EMET 430 is a transmitter-receiver.

According to one supplemental embodiment of the present invention, the microcontroller 460 generates the first electrical signal based on information contained in a message previously received. This may typically be information of “single token” type. According to this embodiment of the invention, the message may be received via a sound signal picked up by the electromechanical transducer TRAN 420, of piezoelectric type, or via a light signal received by a receiver able to pick up light signals. The information contained in the message may be extracted by the microcontroller and encrypted by using the encryption key recorded in the nonvolatile memory ROM 463 in order to generate the authentication signal. Thus, a device TAB 310 receiving the authentication signal, or the server SRV 320 to which the authentication signal would be transmitted, could verify the authenticity of the authentication device 200 by verifying that the encryption key used by the authentication device 200 is in fact the encryption key associated with the authentication device 200. In this embodiment, the information contained in the message is information of “single token” type and the process of authentication of the authentication device 200 involves for example the steps of:
prior association by the server SRV 320 of an identifier of an authentication device 200 with an encryption key, the identifier and the encryption key being recorded in a database BDD 330 and recorded in the nonvolatile memory ROM 463 during the phase of fabrication or initialization of the authentication device 200,
sending by the authentication device 200 of a first signal to the device TAB 310, this first signal may be an authentication signal generated without encryption of any single token, or any other predetermined signal informing the device TAB 310 that a single token needs to be sent to the authentication device 200 for the generation of an authentication signal,
reception by the device TAB 310 of the first signal,
sending by the device TAB 310 to the server SRV 320 of a request for a single token,
sending of a single token by the server SRV 320 to the device TAB 310,
reception by the device TAB 310 of the single token,
transmission by the device TAB 310 of a light or sound message, depending on the embodiment of the invention, to the authentication device 200, the message containing the single token,
reception by the authentication device 200 of the message and generation in response of an authentication signal containing the identifier of the authentication device 200 and the single token encrypted with the encryption key retrieved from the nonvolatile memory ROM 463,
reception by the device TAB 310 of the authentication signal and extraction of the identifier and the encrypted single token, and then transmission of the identifier and of this encrypted single token to the server SRV 320,
reception by the server SRV 320 of the encrypted single token by the authentication device 200 and verification that the encrypted single token received corresponds to the single token retrieved from the database BDD 330 and encrypted by the encryption key associated with the identifier received; if the two encryptions of the single token match up, then the server SRV 320 sends a validation message to the device TAB 310 informing it that the authentication of the authentication device 200 was successful; otherwise, the server SRV 320 sends a message to the device TAB 310 informing it that the authentication device 200 was not authenticated.

According to one embodiment of the invention, it is presumed that the sound signal emitted by the device TAB 310 is also of short range. Thus, the exchanging of sound signals of short range between the authentication device 200 and the device TAB 310 makes it possible to determine whether the authentication device 200 is at the proper distance from the device TAB 310 for the device TAB 310 to be able to receive the authentication signal. If the authentication device 200 does not receive the sound signal emitted by the device TAB 310, the authentication device determines that it is too far away from the device TAB 310. The user may then be asked to repeat the movement. In one embodiment, the authentication device comprises a second indicator device, such as, for example, a light-emitting diode, which lights up when, after the issuing of an authentication signal, the authentication device 200 does not receive in return a sound signal emitted by the device TAB 310, which then means for example that it is too far away from the device TAB 310.

According to one supplemental embodiment of the present invention, the electromechanical transducer TRAN 420 is of the electro-active polymer type. The use of an electromechanical transducer TRAN 420 of electro-active polymer type enables a better energy efficiency as compared to other technologies of ceramic or piezoelectric composite type, as well as reduced weight and footprint, enabling the manufacture of a more compact or lightweight authentication device 200. Moreover, an electromechanical transducer TRAN 420 of electro-active polymer type is generally sturdier than an electromechanical transducer of ceramic and enables more complex forms of transducers, which allows for better integration in the authentication device 200 and a broader range of forms for the body of the authentication device 200. In fact, due to the plasticity of electro-active polymers, they can be molded or printed in any desired form.

More generally, the use of an electromechanical transducer of electro-active polymer type enables a simplified design of the authentication device 200, in particular by the integration of some or all of the mechanical pulse regulator REGM 410, the electromechanical transducer TRAN 420 and the transmitter EMET 430, and thus a reduction in the manufacturing costs of the authentication device 200. Hence, the use of electro-active polymer for the fabrication of springs or elastic elements contained in the mechanical pulse regulator REGM 410 makes it possible to integrate the functionalities of the electromechanical transducer TRAN 420 in the mechanical pulse regulator REGM 410. The electromechanical transducer TRAN 420 and the mechanical pulse regulator REGM 410 thus form a single module. Likewise, the functionalities of the transmitter EMET 430 can also be integrated in this same module, hence providing a mechanical simplification of the authentication device 200. This simplification allows in the end a reduction in manufacturing costs of the authentication device 200.

FIG. 6 illustrates schematically an example of the outer appearance of an authentication device 600 according to a supplemental embodiment of the present invention. According to this supplemental embodiment of the invention, the authentication device 600 comprises a battery in place of the electromechanical power supply mechanism composed of the previously described elements 410, 420 and 450. This makes it possible to simplify the architecture of the authentication device 200 at the price of a loss of energy autonomy. Since the battery needs to be recharged or replaced, the authentication device 600 may include a hatch for access to the battery or a port for recharging. In one alternative embodiment of the invention, the battery is not accessible or rechargeable, and therefore the authentication device 600 is unusable when the battery has run down. This last particularity enables a control of the use of the authentication device 600, making sure of its operating period. It is thus possible to use the battery capacity in order to provide for a longer or shorter period of use.

The authentication device 600 may be visually similar to the authentication device 200, that is resembling a pad. The authentication device 600 comprises a handle 620, similar to the handle 220, and a stamp 610, similar to the stamp 210. The authentication device 600 is distinguished from the authentication device 200 by the additional presence of a plurality of pins, or studs, arranged on one face of the authentication device 600. These pins are disposed, in FIG. 6, beneath the authentication device 600, that is, beneath the stamp 610. FIG. 6 being a profile view of the authentication device 600, only three pins 650, 660 and 670 are represented. The pins are arranged so as to extend beyond the stamp 610 beneath the authentication device 600 and such that the ends of the pins lie in the same plane parallel to the base of the authentication device 600. In other words, when the authentication device 600 is placed vertically, as represented in FIG. 6, the plane formed by the end of the pins is horizontal. According to the embodiment illustrated in FIG. 6, the pins are composed of a flexible material. For example, the pins are made of rubber whose hardness is between Shore A 25 and Shore A 75, such as Shore A 50 (Shore A referring to the Shore hardness scale for soft materials). This flexibility enables a contact of the pins with the surface of a screen of an electronic device of the smartphone or tablet type without risk of damaging the screen. At least two pins out of the plurality of pins consist of an electrically conductive material (hereinafter, a “conductor”), the other pins being composed of an electrically insulating material. According to one embodiment of the invention, the two materials have the same outer appearance in order to prevent the conductive and insulating pins from being distinguished visually or by touch by a user. Thus, the conductive material may be rubber with carbon filling and the insulating material may be a rubber without carbon, the two materials being chosen to be of the same hardness between Shore A 25 and Shore A 75, such as Shore A 50.

According to one embodiment of the invention, the body of the authentication device 600, that is, the handle 620 and/or the stamp 610, is covered or constituted, at least in part, of an electrically conductive material. Preferably, the handle 620, which is the part of the authentication device 600 held in the hand by a user, is covered with the conductive material. An electrical continuity is ensured between the part of the authentication device 600 covered by the conductive material and all of the pins consisting of a conductive material. Thus, when the authentication device 600 is held in the hand by a user, the pins consisting of a conductive material may be used to interact with a touch screen using a so-called capacitive touch technology (hereinafter, “capacitive touch screen”). Said material covering the authentication device 600 may also be flexible in order to avoid scratching the screen of an electronic device during the handling of the authentication device 600. The material covering at least partly the authentication device 600 may be a rubber with hardness between Shore A 40 and Shore A 90, such as Shore A 65. According to one embodiment of the invention, the authentication device 600 is entirely covered by a flexible material.

The authentication device 600 comprises at least one means of detecting a pressure exerted on at least one pin. For example, a pin comprises a switch on its inside, which is activated when that pin is pressed against a surface, such as the screen of an electronic device. The pins may be mounted on a movable support inside the authentication device 600, with a return spring. A pressure on the pins may then trigger a switch connected to the movable support.

FIG. 7 is a bottom view of the authentication device 600 according to the supplemental embodiment of the invention as illustrated in FIG. 6. The pins 650, 660 and 670 appear in profile in FIG. 6. According to the embodiment illustrated in FIG. 7, the authentication device 600 comprises nine pins 650, 660, 670, 751, 761, 771, 752, 762 and 772, arranged “3 by 3”. The number of pins may be different, as well as their arrangement. At least two out of these pins consist of an electrically conductive material. The other pins consist of an electrically insulating material. The pins consisting of a conductive material determine a geometrical shape in the horizontal plane. It is thus possible to define the perimeter of said geometrical shape, corresponding to a distance between the pins consisting of a conductive material. An area of the geometrical shape may also be defined. The geometrical shape may be defined by the angles formed by the lines joining the different points of the geometrical shape. A parameter, hereinafter called “pattern”, may thus be determined as a function of the positioning of the pins consisting of conductive material. The pattern may correspond to the perimeter of the geometrical shape, alone or in combination with other attributes of the geometrical shape. The same geometrical shape may be constituted by different pins. Thus, for example, having only the pins 752, 751, 650 and 660 consisting of a conductive material in the end results in the same L-shaped geometrical form as having the pins 751, 761,771 and 772 so formed, among other possibilities. These two choices of the group of pins consisting of a conductive material in the end determine the same pattern.

According to one embodiment of the invention, the pins consisting of a conductive material and the pins consisting of an insulating material are visually and tactilely identical. It is thus not possible for a user of the authentication device 600 to distinguish which pins consist of a conductive material by simply looking at the pins. For example, all the pins are constituted of a rubber with hardness between Shore A 25 and Shore A 75, for example Shore A 50. The rubber making up the conductive pins is moreover filled with carbon in order to make it a conductor of electricity. It is thus impossible to differentiate a conductive pin from an insulating pin by sight or by touch. Thus, it is not possible for a user of the authentication device 600 to discover the pattern corresponding to the arrangement of the pins consisting of a conductive material by simply looking at the pins. More generally, the totality of the pins, whether or not conductive, contributes to the stability of the authentication device 600 when it is placed upright. The totality of the pins composed of a flexible material also contributes to the shock absorbing when the authentication device 600 is pressed against a touch screen of an electronic device, which reduces the risks of scratching or damaging said screen.

FIG. 8 illustrates schematically an example of hardware architecture of an authentication device 600 according to the supplemental embodiment of the invention as illustrated in FIG. 6. In this embodiment of the invention, the authentication device 600 comprises a microcontroller 840, possibly identical to the microcontroller 460. The authentication device 600 comprises a battery BATT 820 enabling an electrical power supply for the microcontroller 840. The authentication device 600 comprises a transmitter EMET 830, the transmitter EMET 830 enabling the emitting of an authentication signal.

In this embodiment of the invention, the authentication device 200 comprises a detector PRESS 810, such as a switch, placed on the so-called stamp portion 610 of the authentication device 200. The detector PRESS 810 is possibly incorporated inside one of the previously described flexible pins. The detector PRESS 810 makes it possible to detect the pressing of the authentication device 200 against a surface, such as the capacitive touch screen of an electronic device such as the device TAB 310. The detector PRESS 810, for example a switch or push button, thus makes is possible to ensure that the authentication device 600 has been pressed against the device TAB 310. The detection of a pressure by the detector PRESS 810 initiates the emission by the authentication device 600 of the authentication signal. This emission may be contingent upon the simultaneous detection of a predetermined fingerprint by a fingerprint reader LECT 850.

The microcontroller 840 is an electronic device having a programmable data processing unit (Central Processing Unit) CPU 841, a random access memory RAM 842, a nonvolatile memory or storage module ROM 843 and one or more input/output interfaces E/S 844. The interfaces E/S 844 may comprise analog-digital (CAN) or digital-analog (CNA) signal converters, which may comprise a pulse width modulation (PWM) module. When electrically energized by the battery BATT 820, the microcontroller 840 is adapted to generate the emission of a first electrical signal at the output of an output interface E/S 844, the first electrical signal corresponding to the authentication signal to be emitted by the transmitter EMET 830.

According to alternative embodiments, the functionalities of the microcontroller 840 are performed by a programmable logic circuit (field-programmable gate arrays—FPGA), a digital signal processor (DSP), an application-specific integrated circuit (ASIC) or any other equivalent device.

According to one particular embodiment, said interface E/S 844 is connected to a transmitter EMET 830, which then emits the authentication signal. Depending on the nature of the transmitter EMET 830, this may be a signal of sound type (transmitter EMET 830 of loudspeaker type, for example), of visual type (transmitter EMET 830 of light-emitting diode type, for example), or any other type. The detector PRESS 810 and/or the print reader LECT 850 are possibly connected to the microcontroller 840 via the interface E/S 844.

According to one embodiment of the invention, the transmitter EMET 830 is a transmitter compatible with radio type technologies such as, for example, Bluetooth®, near field communication (NFC), radio-frequency identification (RFID), or WiFi (“Wireless Fidelity”). According to one supplemental embodiment, the transmitter EMET 830 is a transmitter-receiver, that is, it may also receive a signal and enables bidirectional communication.

Thus, the authentication signal is designed to be received by an electronic device, such as the device TAB 310, illustrated in FIG. 3, which comprises a means of reception adapted to the signal emitted, for example a microphone in the case of an authentication sound signal. The use of an authentication signal of sound type thus allows a broad compatibility of the uses of the authentication device 600 with electronic devices of smartphone or tablet type, which almost always contain a microphone.

The authentication device 600 comprises the pins described above, not represented in FIG. 8. The use of an authentication signal of sound type in combination with the pattern made up of the conductive pins enables a synergy. In fact, on the one hand, the use of an authentication sound signal enables a virtual infinity of different authentication sound signals, but it has the inconvenience of being able to be captured by nearby electronic devices. Thus, typically, an authentication sound signal emitted by the authentication device 600 may be received by an electronic device situated a few centimeters or a few meters away, depending on the sensitivity of the microphone of the electronic device. On the other hand, the patterns made up of several conductive pins are finite in number, yet in order to be detected by an electronic device they require a physical contact between that electronic device and the authentication device 600. The detector PRESS 810, such as a switch or a push button, thus guarantees that an authentication signal is emitted only when the authentication device 600 is pressed against a touch screen of an electronic device.

In other words, an electronic device which is awaiting authentication by a single sound signal might potentially receive a sound signal destined for another electronic device. The combination of the authentication by a sound signal and by pins thus makes it possible, for example, to trigger a listening window (aperture of the microphone) only when a pattern is detected by the electronic device, which reduces the risk of receiving a sound signal destined for another electronic device.

According to one supplemental embodiment, a predetermined bit of information is recorded in the nonvolatile memory ROM 843 of the microcontroller 840. This information may be recorded in the memory during the course of the fabrication of the authentication device 600 or during a later phase of configuration of the authentication device 600, for example by means of a programming interface, not shown. The predetermined information may include several bits of information such as an identifier of the authentication device 600 or an encryption key.

According to one embodiment, the nonvolatile memory ROM 843 is of the non-rewritable type, and thus it is no longer possible to modify or erase the predetermined information once this has been recorded.

It should be noted that, according to one embodiment, a program containing operating instructions of the microcontroller is recorded in this nonvolatile and non-rewritable memory ROM 843. This makes it possible to guard against any modification of the mode of operation of the authentication device 600. Thus, when the microcontroller 840 is energized by the battery BATT 820, the microcontroller 840 may be adapted to retrieve the predetermined information recorded in the memory or storage module ROM 843 and to generate from this predetermined information the emission of a first electrical signal corresponding to the authentication signal to be emitted by the transmitter EMET 830.

According to one supplemental embodiment of the invention, the authentication device 600 comprises a fingerprint reader LECT 850. This fingerprint reader LECT 850 makes it possible for the issuance of the authentication sound signal to be contingent upon the detection of one or more predetermined fingerprints. This allows the providing of a supplemental level of security by guaranteeing that the user of the authentication device 600 is authorized to make use of it. Thus, information corresponding to the fingerprints of the users authorized to make use of the authentication device 600 may be previously recorded in the nonvolatile memory ROM 843 during the manufacturing phase or during a later phase of configuration. If, during the use of the authentication device 600, no print corresponding to a print registered in the nonvolatile memory ROM 843 is retrieved by the microcontroller 840, then the process of issuing the authentication signal is halted, without issuing an authentication signal. According to one supplemental embodiment of the invention, a predetermined signal corresponding to an error code is then issued in place of the authentication signal. According to an alternative embodiment of the invention, a random signal is issued in place of the authentication signal

According to one supplemental embodiment of the invention, data corresponding to the fingerprint read by the fingerprint reader LECT 850 is contained in the authentication signal emitted by the authentication device 600. The functionality of verification of the fingerprint based on data corresponding to the fingerprint read may thus be shifted to an electronic device, such as the device TAB 310 or to a server SRV 320, as illustrated in FIG. 3.

According to one embodiment of the invention, not described, it is possible to design an authentication device comprising the electromechanical power supply mechanism as described in the description of the authentication device 200. This authentication device may thus do without the battery BATT 820. As previously noted, the authentication device 200 may include a detector. The detector makes it possible to detect the pressing of the authentication device 200 against a surface, such as a surface of the device TAB 310, and to release a striker, thus freeing up the mechanical impulse when the authentication device 200 is pressed against the device TAB 310. The detector is thus the detector PRESS 810 previously described. Advantageously, the detector PRESS 810 is thus placed in a flexible pin and is able to perform the function of releasing the striker, in the end resulting in the emitting of the authentication signal by the transmitter EMET 830. In the same way as previously described, the transmitter EMET 830 can be a piezoelectric type.

FIG. 9 is a flow chart of a method of authentication utilizing an authentication device according to the supplemental embodiment of the invention as illustrated in FIG. 6.

The authentication device 600 may be used in the system described in FIG. 3 in identical fashion to the authentication device 200. The device TAB 310 executes a dedicated application. The device TAB 310 comprises a capacitive touch screen and a receiver. According to one embodiment of the invention, the receiver is a microphone. Said application enables the selection of an identifier of an authentication device 600 out of a plurality of possible identifiers. Thus, each identifier corresponds to a unique authentication device 600, each authentication device 600 corresponding for example to a company or to a user, such as a merchant. The method makes it possible to authenticate the identifier selected by the authentication device 600 corresponding to this identifier. In one scenario of use, the application is an application for management of the delivery of mail, one authentication device 600 being associated with each recipient of mail. A person delivering this mail uses an electronic device such as the device TAB 310 to have the user and recipient of the mail validate the proper reception of this mail by means of his corresponding authentication device. The device TAB 310 executes a dedicated application.

Prior to step 901, the user of the device TAB 310 executes an application enabling an authentication by means of an authentication device 600. The user selects, possibly via a graphic interface presented on a screen of the device TAB 310, an identifier associated with an authentication device 600. The identifier and the authentication device 600 are associated with a user whose identity has possibly been previously verified. According to one embodiment of the invention, the selection of the identifier is automatic, for example, by taking as the identifier the one corresponding to the recipient of the mail at the time of delivery to a recipient. The device TAB 310 then retrieves in a database the authentication data corresponding to the identifier being authenticated. This data includes an authentication signal and a pattern associated with an authentication device 600. According to one embodiment of the invention, the authentication data does not include the authentication signal itself, but an imprint (“hash”) thereof.

Once an identifier has been selected, the application waits until detecting inputs on its capacitive touch screen.

In step 901, at least one input is detected on the capacitive touch screen of the device TAB 310. This corresponds to making contact with all the pins of the authentication device 600 on the capacitive touch screen of the device TAB 310. Thus, only the pins consisting of a conductive material are detected. The electrical continuity between the pins consisting of a conductive material and the body of the authentication device 600 made of a conductive material enables the proper working of the capacitive touch screen if the body of the authentication device 600 is held in the hand of a user. The authentication device 600, detecting the contact produced with the capacitive touch screen of the device TAB 310 by means of the detector PRESS 810, triggers the authentication signal by means of the transmitter EMET 830. According to one embodiment of the invention, the transmitter EMET 830 is a loudspeaker emitting a sound or ultrasound signal. The emission may also be contingent on the presence of a predetermined fingerprint on the fingerprint reader LECT 850.

In a step 920, the device TAB 310 receives the authentication signal. For this, either the device TAB 310 is permanently in listening mode or the detection of inputs during step 901 triggers a listening phase for a predetermined time.

Once the authentication signal has been received, in a step 921, the device TAB 310 decodes the authentication signal. This step may be optional or it may involve the verification of an error corrector code. This step may correspond to the calculating of a “hash” based on the authentication signal.

In a step 910, the device TAB 310 determines a pattern as a function of the geometrical shape formed by the inputs detected on the capacitive touch screen. The pattern may be determined by a distance calculated between the different inputs. Each input on the capacitive touch screen corresponds to the position of a pin consisting of a conductive material.

An optional step 911 of verification of the determined pattern may be carried out.

In a step 930, the device TAB 310 verifies that the authentication signal received during step 920 is in fact equal to the authentication signal of the determined pattern. For this, the device TAB 310 compares the two authentication signals or rather their “hashes”.

The device TAB 310 verifies at the same time that the pattern determined during step 910 indeed corresponds to the pattern associated with the identifier.

If the authentication signals (or their hashes) are identical and the patterns match up, the authentication is then validated (step 940). Otherwise, the authentication is invalidated (step 950).

The method previously described may correspond to a scenario of managing a loyalty card by a merchant. The loyalty card then becomes virtual, being integrated in an application. In this scenario, each user or customer has an electronic device, such as the device TAB 310, executing an application for loyalty card management. This application may be dedicated to a merchant. On the contrary, this application may enable the management of a plurality of loyalty programs of a plurality of merchants. A customer who wishes to validate his virtual loyalty card opens the application and selects, if necessary, the corresponding merchant. That merchant then stamps the screen of the electronic device of the customer by means of the authentication device 600. The detection of the pattern and the reception of the sound signal, the two being combined and correspond to the merchant, makes possible the validation of the “rubber stamping” by the application. The virtual loyalty card can then be incremented.

According to another scenario of use, not represented, the authentication device 600 can make possible the identification of a user of the authentication device 600, the user having been previously associated with the authentication device 600. Thus, a database may contain lists enabling the matching up of a user (first name, last name, etc.) and an authentication device 600 (serial number).

FIG. 10 is a cross section view of a body 10 of an authentication device 600 according to a supplemental embodiment of the present invention. According to this supplemental embodiment, the authentication device 600 is composed of a monobloc body 10, obtained for example by molding. The handle 620 and the stamp 610 are then a single identical piece. The body 10 is composed of a flexible material, such as rubber with hardness between Shore A 40 and Shore A 90, in order to prevent any contact of the authentication device 600 with a screen of an electronic device from scratching the screen. The body 10 is for example composed of a rubber with hardness of Shore A 65. The body 10 is composed of an electrically conductive material, such as rubber with hardness of Shore A 65, filled with carbon. The body 10 may have an axis of symmetry about the vertical axis, the authentication device 600 then having a “rounded” shape. The body 10 may have two planes of symmetry according to two orthogonal vertical planes having at their intersection the vertical axis of the body 10, the authentication device 600 then having a “square” shape. Other shapes are possible. The body 10 may be hollow, in particular having two empty zones 16 and 17. According to one embodiment, the zone 16 is designed to hold a microcontroller, such as the microcontroller 840. The microcontroller may take the form of a printed circuit, which printed circuit is of a size adapted to being force-fitted into a groove 15 devised in the body 10 so as to be held in place. The printed circuit may comprise in its lower face, that is, the face opposite the zone 16, a push button, such as the detector PRESS 810. A transmitter, such as the transmitter 830, may be secured to the printed circuit, or directly integrated in the printed circuit. The transmitter may be a loudspeaker of size adapted to being inserted inside the body 10. In the same way, a plate or support plate may be inserted into a groove 12. A so-called holding plate may be inserted into a groove 11. Such a so-called holding plate is illustrated in FIG. 11 for the case of a “round” authentication device 600. In the case of a “square”-shaped authentication device 600, a holding plate would have the visual appearance of the view 610. The support plate is possibly made of an electrically conductive material. The support plate is typically metallic. In this case, if the body 10 is also made of an electrically conductive material, a protection of Faraday cage type is produced, making it possible to protect the printed circuit, and more generally any microcontroller arranged inside the authentication device 600, for example in the zone 16 or 17. The microcontroller is thus protected against any electromagnetic interference, which preserves its lifetime. A plate or an element making it possible to close the Faraday cage is inserted into a groove 20 in order to close the Faraday cage at the upper part of the authentication device 600. This element may be a fingerprint reader 630, which is thus ideally arranged on the upper portion of the authentication device 600. Alternatively, the upper zone of the body 10 in which the groove 20 is represented is solid, that is, no opening is present in the upper portion of the body 10.

The zone 17 inside the body 10 may contain a battery, such as the battery 820. This zone 17 may alternatively contain electromechanical means of generating an electrical power supply, as previously described in FIG. 4, that is, the elements 410, 420 and 450.

According to one alternative embodiment of the invention, the body 10 is composed of several parts. These parts may be assembled in permanent fashion, for example by welding or gluing. These parts may be assembled in non-definitive fashion, such as by clipping, crimping or screwing.

FIG. 11 is an illustration of a part 20 designed to be integrated in the authentication device as illustrated in FIG. 10, that is, a so-called holding plate 20. The form of the plate 20 is adapted to its forceful insertion into the groove 11 of the body 10. Openings are devised in the holding plate 20 in order to allow pins to pass through, such as the pins 750, 760, 770, 751, 761, 771, 752, 762, 772. One such pin is illustrated in FIG. 12. A serial number may be written on this holding plate 20 or alternatively on the body 10 of the authentication device 600. During a phase of configuration, the authentication device 600 may be activated in order to detect the pattern of the authentication device 600 as well as the authentication signal emitted. It is then possible to associate said pattern and authentication signal with the serial number, enabling the subsequent identification of the authentication device 600 by a unique identifier corresponding to the serial number. Alternatively, or additionally, a serial number may be inscribed on the printed circuit, possibly in association with the authentication signal.

FIG. 12 is a cross section view of a pin 30 designed to be integrated in the authentication device as illustrated in FIG. 10. The pin 30 here is represented in a vertical position. The upper part of the pin 30 corresponds to the base, designed to be in contact with the support plate. The lower part corresponds to the part designed to be placed in contact with a touch screen of an electronic device. A pin 30 may thus be composed of a flexible material, such as a rubber with hardness between Shore A 25 and Shore A 75, for example Shore A 50. Certain pins 30 are composed of a rubber filled with carbon in order to make them conductors of electricity. The base of each pin 30 being broader than the openings devised in the holding plate 20, the pins are held with their bases being possibly pressed between the holding plate 20 and the support plate. A pressing of the authentication device 600 against a touch screen of an electronic device pushes the pins upward, guaranteeing a contact of the bases of each pin, especially the pins composed of a conductive material, with the support plate, composed of a conductive material. According to one supplemental embodiment of the invention, the support plate is pierced at its center, opposite the opening corresponding to the central pin (pin 761). Thus, a rigid rod can be inserted into the pin 761 so that a pressure on this pin 761 is able to activate a push button, such as the detector PRESS 810, arranged on the lower face of a printed circuit inserted into the groove 15. The rigid rod then passes through the opening devised in the support plate.

According to one supplemental embodiment of the invention, certain pins comprise rigid rods, bearing against the support plate, in order to control the depth of submergence of the pins when the authentication device 600 is pressed against a surface, such as a screen of an electronic device.

According to one supplemental embodiment of the invention, the number of pins composed of a conductive material is less than or equal to four. In fact, having two, three or four pins made of an electrically conductive material enables a good compromise between, on the one hand, having a sufficient number of different patterns and, on the other hand, ensuring a rapid detection of said pattern by a touch screen of an electronic device. In fact, when the pins composed of a conductive material are too many, typically greater than five, the detection of the pattern by a given electronic device may be random or slow. Moreover, certain touch screens do not allow the simultaneous detection of more than five points of contact, these screens being typically designed to be used with the five fingers of the hand.

1. An authentication device designed to be used with an electronic device comprising a capacitive touch screen and a receiver, wherein the authentication device comprises:
a plurality of pins arranged on the same face of the authentication device, at least two pins consisting of a conductive material, the other pins consisting of an insulating material, all the pins having an identical appearance,
means for detecting pressure exerted on at least one pin, and,
means for emitting an authentication signal to be received by the receiver when pressure is detected, the authentication signal being a sound signal.

2. The authentication device as claimed in claim 1, the geometrical positioning of the pins consisting of conductive material constituting a pattern, the pattern being associated with the authentication signal.

3. The authentication device as claimed in claim 1, the authentication device being at least partially made of a conductive material, an electrical continuity being ensured with the pins consisting of a conductive material.

4. The authentication device as claimed in claim 3, the conductive material constituting the pins and/or covering the authentication device being flexible.

5. The authentication device as claimed in claim 1, the authentication device comprising a monobloc and hollow body consisting of a flexible material which is a conductor of electricity, the body comprising at least one groove enabling the insertion of a support plate consisting of an electrically conductive material on which the pins are supported, the interior of the body of the authentication device constituting a Faraday cage.

6. The authentication device as claimed in claim 1, the authentication device further comprising means of reading a fingerprint when a pressure is detected on at least one pin, the authentication signal only being emitted if the fingerprint read corresponds to a predetermined fingerprint.

7. The authentication device as claimed in claim 1, at most four pins consisting of a conductive material, the other pins consisting of an insulating material.

8. A method for authentication of an identifier associated with an authentication device, the method being executed by an electronic device comprising a capacitive touch screen and a receiver and involving the steps of:
receiving a selection of a first identifier associated with a first authentication device,
retrieving a first authentication signal and a first pattern associated with the first identifier,
detecting at least two input points on the capacitive touch screen created by the application of a second authentication device on the capacitive touch screen,
determining a second pattern as a function of the input points detected,
receiving a second authentication signal by means of the receiver,
authenticating the first identifier if the second authentication signal is equal to the first authentication signal and if the second pattern is equal to the first pattern.

9. The method for authentication of an identifier associated with an authentication device as claimed in claim 8, the step of determining a second pattern involving a step of calculating at least one distance between the input points detected on the capacitive touch screen.

10. A computer program comprising instructions embodied in a non-transitory computer readable medium to carry out, by a processor of an electronic device, a method enabling the authentication of an identifier associated with an authentication device when the computer program is executed by the processor, the method being executed by an electronic device comprising a capacitive touch screen and a receiver and involving the steps of:
receiving a selection of a first identifier associated with a first authentication device,
retrieving a first authentication signal and a first pattern associated with the first identifier,
detecting at least two input points on the capacitive touch screen created by the application of a second authentication device on the capacitive touch screen,
determining a second pattern as a function of the input points detected,
receiving a second authentication signal by means of the receiver, and
authenticating the first identifier if the second authentication signal is equal to the first authentication signal and if the second pattern is equal to the first pattern.

11. A non-transitory recording medium, readable by an electronic device, on which is stored the program as claimed in claim 10.

12. A system for authentication of an identifier associated with an authentication device according to claim 1, the system comprising:
the authentication device according to claim 1, and
an electronic device comprising a capacitive touch screen and a receiver, the electronic device being adapted to perform a method for authentication, the method being executed by an electronic device comprising a capacitive touch screen and a receiver and involving the steps of:
receiving a selection of a first identifier associated with a first authentication device,
retrieving a first authentication signal and a first pattern associated with the first identifier,
detecting at least two input points on the capacitive touch screen created by the application of a second authentication device on the capacitive touch screen,
determining a second pattern as a function of the input points detected,
receiving a second authentication signal by means of the receiver, and
authenticating the first identifier if the second authentication signal is equal to the first authentication signal and if the second pattern is equal to the first pattern.
